(19) United States
(12) Patent Application Publication
(10) Pub. No.: US 2020/0028207 A1
(43) Pub. Date: Jan. 23, 2020

(54) LITHIUM ION-CONDUCTING SULFIDE-BASED SOLID ELECTROLYTE CONTAINING SELENIUM AND METHOD FOR PREPARING THE SAME

(71) Applicant: KOREA INSTITUTE OF SCIENCE AND TECHNOLOGY, Seoul (KR)

(72) Inventors: Hyoung chul KIM, Seoul (KR); Hae Weon LEE, Seoul (KR); Byung Kook KIM, Seoul (KR); Jong Ho LEE, Seoul (KR); Ji Won SON, Seoul (KR); Hun Gi JUNG, Seoul (KR); Eu Deum JUNG, Seoul (KR); Ji Su KIM, Seoul (KR); Sung Jun CHOI, Seoul (KR)

(21) Appl. No.: 16/190,023

(22) Filed: Nov. 13, 2018

(30) Foreign Application Priority Data
Jul. 17, 2018 (KR) 10-2018-0082786

(51) Int. Cl. H01M 10/0562; H01M 10/0525

(52) U.S. Cl. CPC H01M 10/0562; H01M 2300/0068; H01M 10/0525

(57) ABSTRACT

Disclosed are a lithium ion-conducting sulfide-based solid electrolyte containing selenium and a method for preparing the same. More specifically, disclosed is a lithium ion-conducting sulfide-based solid electrolyte containing selenium that is capable of significantly improving lithium ion conductivity by successfully replacing a sulfur (S) element with a selenium (Se) element, while maintaining an argyrodite-type crystal structure of a sulfide-based solid electrolyte represented by Li₆PS₅Cl.

### CROSS-REFERENCE TO RELATED APPLICATION

This application claims, under 35 U.S.C. § 119A, the benefit of priority to Korean Patent Application No. 10-2018-0082786 filed on Jul. 17, 2018, the entire contents of which are incorporated herein by reference.

### BACKGROUND

### (a) Technical Field

The present invention relates to a lithium ion-conducting sulfide-based solid electrolyte containing selenium and a method for preparing the same. More specifically, the present invention relates to a lithium ion-conducting sulfide-based solid electrolyte containing selenium that is capable of significantly improving lithium ion conductivity by successfully replacing a sulfur (S) element with a selenium (Se) element, while maintaining an argyrodite-type crystal structure of a sulfide-based solid electrolyte represented by Li₆PS₅Cl.

### (b) Background Art

Secondary battery technologies used for electronic devices such as cellular phones and notebooks as well as vehicles such as hybrid vehicles and electric vehicles require electrochemical devices with better stability and higher energy density.

Currently, conventional secondary battery technologies have a limitation on improving stability and energy density, because most of them have cells based on an organic solvent (organic liquid electrolyte).

On the other hand, all-solid batteries using inorganic solid electrolytes have recently attracted a great deal attention because they are based on technologies excluding use of an organic solvent and thus enable cells to be produced in a safer and simpler manner.

However, the most representative example of a solid electrolyte for all-solid batteries, which was developed to date, is a material based on lithium-phosphorus-sulfur (Li—P—S, LPS), which is needed to be actively researched for mass-production due to drawbacks such as low room-temperature lithium ion conductivity, instability of crystal phases, poor atmospheric stability, process restrictions and narrow regions of high conductive phase composition ratios.

U.S. Pat. No. 9,899,701 B2 reports Li₆PS₅Cl which is a lithium ion-conducting material with an argyrodite-type crystal structure. A crystal phase of Li₆PS₅Cl is composed of lithium (Li), phosphorus (P), sulfur (S) and chlorine (Cl) and is stable because it is produced at a relatively high temperature. Although Li₆PS₅Cl has a higher room-temperature lithium ion conductivity of about 2 mS/cm than conventional materials, it should secure a high lithium ion conductivity of 5 mS/cm or more for application to next-generation technologies. However, this issue remains unsolved.

### PATENT DOCUMENT

U.S. Pat. No. 9,899,701 B2

The above information disclosed in this Background section is provided only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art.

It is an object of the present invention to provide a lithium ion-conducting sulfide-based solid electrolyte with high lithium ion conductivity and a method for preparing the same.

The objects of the present invention are not limited to those mentioned above. The objects of the present invention will be clearly understood from the following description and implemented by means described in the claims and combinations thereof.

In one aspect, the present invention provides a lithium ion-conducting sulfide-based solid electrolyte containing selenium represented by the following Formula 1 and having an argyrodite-type crystal structure:

Li₆PS₅₋ₐSeₐX [Formula 1]

wherein X is at least one halogen element selected from the group consisting of fluorine (F), chlorine (Cl), bromine (Br) and iodine (I) elements, and a satisfies 0<a<3.

The sulfide-based solid electrolyte may have a peak in ranges of 2θ=15.60°±1.00°, 2θ=18.04°±1.00°, 2θ=25.60±1.00°, 2θ=30.12°±1.00°, 2θ=31.46°±1.00°, 2θ=40.05±1.00°, 2θ=45.26°±1.00°, 2θ=48.16°±1.00°, 2θ=52.66°±1.00° and 2θ=59.00±1.00° when measuring X-ray diffraction (XRD) patterns using a CuKα-ray.

Regarding the sulfide-based solid electrolyte, as a in Formula 1 increases, in the X-ray diffraction (XRD) patterns using a CuKα-ray, a 2θ value of a peak of (222) plane of an argyrodite-type crystalline phase may shift to a lower angle which corresponds to a decrease in an angle higher than 0° and not higher than 0.3°.

The sulfide-based solid electrolyte may have a distribution of anionic clusters of PS₄³⁻ and P₂S₆⁴⁻.

The sulfide-based solid electrolyte may satisfy the following Equation 1:

$$80 \leq \frac{100 \times I ( {PS}_{4}^{3 -} )}{I ( {P}_{2} {S}_{6}^{4 -} ) + I ( {PS}_{4}^{3 -} )} < 100 \qquad [ Equation 1 ]$$

wherein I(P₂S₆⁴⁻) is an area of a Raman spectrum peak at about 380 cm⁻¹; and I(PS₄³⁻) is an area of a Raman spectrum peak at about 425 cm⁻¹.

A lattice constant of the argyrodite-type crystal structure of the sulfide-based solid electrolyte may be 9.75 Å to 9.85 Å.

The sulfide-based solid electrolyte may have a ³¹P-NMR spectrum having a peak in each of ranges of 20.0 ppm to 25.0 ppm, 40.0 ppm to 45.0 ppm, 60.0 ppm to 65.0 ppm and 95.0 ppm to 100.0 ppm.

In another aspect, the present invention provides a method for preparing a lithium ion-conducting sulfide-based solid electrolyte containing selenium including preparing a mixture comprising lithium sulfide (Li₂S), diphosphorus pentasulfide (P₂S₅) and lithium halide (LiX), and grinding the mixture, wherein the grinding of the mixture is carried out by adding selenium (Se) and simple-substance phosphorus to the mixture to substitute a part of sulfur elements by a selenium element, as shown in the following Formula 1:

Li₆PS₅₋ₐSeₐX [Formula 1]

wherein X is at least one halogen element selected from the group consisting of fluorine (F), chlorine (Cl), bromine (Br) and iodine (I) elements, and a satisfies 0<a<3.

The sulfide-based solid electrolyte may have an argyrodite-type crystal structure.

The grinding may be carried out by applying a force of 38G or more to the mixture.

The method may further include heat-treating the ground mixture at a temperature of 300° C. to 1,000° C. for 1 to 100 hours.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 shows results of XRD analysis according to Test Example 1 of the present invention;

FIG. 2 shows results of Raman analysis according to Test Example 2 of the present invention;

FIG. 3 shows results of measurement of lithium ion conductivity according to Test Example 3 of the present invention;

FIG. 4 shows results of XRD analysis according to Test Example 4 of the present invention;

FIG. 5 shows results of Raman analysis according to Test Example 5 of the present invention;

FIG. 6 shows results of measurement of lattice constant according to Test Example 6 of the present invention;

FIG. 7 shows results of ³¹P-NMR analysis according to Test Example 7 of the present invention; and

FIG. 8 shows results of measurement of lithium ion conductivity according to Test Example 8 of the present invention.

### DETAILED DESCRIPTION

The objects described above, and other objects, features and advantages will be clearly understood from the following preferred embodiments with reference to the annexed drawings. However, the present invention is not limited to the embodiments and may be embodied in different forms. The embodiments are suggested only to offer thorough and complete understanding of the disclosed context and sufficiently inform those skilled in the art of the technical concept of the present invention.

Like reference numbers refer to like elements throughout the description of the figures. In the drawings, the sizes of structures are exaggerated for clarity. It will be understood that, although the terms first, second, etc. may be used herein to describe various elements, these elements should not be limited by these terms and are used only to distinguish one element from another. For example, within the scope defined by the present invention, a first element may be referred to as a second element and similarly, a second element may be referred to as a first element. Singular forms are intended to include plural forms as well, unless context clearly indicates otherwise.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element or an intervening element may also be present. It will also be understood that, when an element such as a layer, film, region or substrate is referred to as being “under” another element, it can be directly under the other element or an intervening element may also be present.

Unless context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures among other things. For this reason, it should be understood that, in all cases, the term “about” should modify all the numbers, figures and/or expressions. In addition, when numerical ranges are disclosed in the description, these ranges are continuous and include all numbers from the minimum to the maximum including the maximum within the ranges unless otherwise defined. Furthermore, when the range is referred to as an integer, it includes all integers from the minimum to the maximum including the maximum within the range, unless otherwise defined.

It should be understood that, in the specification, when the range is referred to regarding a parameter, the parameter encompasses all figures including end points disclosed within the range. For example, the range of “5 to 10” includes figures of 5, 6, 7, 8, 9, and 10, as well as arbitrary sub-ranges such as ranges of 6 to 10, 7 to 10, 6 to 9, and 7 to 9, and any figures, such as 5.5, 6.5, 7.5, 5.5 to 8.5 and 6.5 to 9, between appropriate integers that fall within the range. In addition, for example, the range of “10% to 30%” encompasses all integers that include numbers such as 10%, 11%, 12% and 13% as well as 30%, and any sub-ranges of 10% to 15%, 12% to 18%, or 20% to 30%, as well as any numbers, such as 10.5%, 15.5% and 25.5%, between appropriate integers that fall within the range.

Hereinafter, a lithium ion-conducting sulfide-based solid electrolyte containing selenium and a method for preparing the same according to an embodiment of the present invention will be described in detail.

The method for preparing a sulfide-based solid electrolyte according to the embodiment of the present invention includes preparing a mixture containing raw materials such as lithium sulfide (Li₂S), diphosphorus pentasulfide (P₂S₅) and lithium halide (LiX), and grinding the mixture.

The sulfide-based solid electrolyte prepared by the method is a compound represented by the following Formula 1:

Li₆PS₅₋ₐSeₐX [Formula 1]

wherein X is at least one halogen element selected from the group consisting of fluorine (F), chlorine (Cl), bromine (Br) and iodine (I) elements; and a satisfies 0<a<3.

Preferably, a satisfies 0.25≤a≤0.5.

The sulfide-based solid electrolyte has an argyrodite-type crystal structure, which can be clearly seen from results of X-ray diffraction (XRD) analysis of the sulfide-based solid electrolyte. This will be described later.

The sulfide-based solid electrolyte may further include an element selected from the group consisting of boron (B), carbon (C), nitrogen (N), aluminum (Al), silicon (Si), vanadium (V), manganese (Mn), iron (Fe), cobalt (Co), nickel (Ni), copper (Cu), zinc (Zn), gallium (Ga), germanium (Ge), arsenic (As), silver (Ag), cadmium (Cd), tin (Sn), antimony (Sb), tellurium (Te), lead (Pb), bismuth (Bi) and a combination thereof. The element may be substituted with a phosphorus (P) or sulfur (S) element when included in the sulfide-based solid electrolyte.

When compared with conventional materials represented by Li₆PS₅Cl, the sulfide-based solid electrolyte is characterized in that a part of sulfur (S) elements are substituted by selenium (Se) elements. Although selenium (Se) is a chalcogen group element like sulfur (S), it has a weaker strain energy when conducting a lithium ion due to larger ionic radius thereof than sulfur (S). Accordingly, by substituting a part of sulfur (S) elements by selenium (Se) elements, like the sulfide-based solid electrolyte according to the present invention, lithium ion conductivity can be improved.

The present inventors could successfully substitute only a part of sulfur (S) elements by a selenium (Se) element by conducting the following operations, without affecting other elements present in the sulfide-based solid electrolyte.

The method for preparing a sulfide-based solid electrolyte according to the present invention includes use of selenium (Se) and simple-substance phosphorus, as raw materials, in addition to lithium sulfide (Li₂S), diphosphorus pentasulfide (P₂S₅) and lithium halide (LiX). As used herein, the term “simple substance” refers to a single element substance which includes one element and thus has inherent chemical properties.

The raw material is reorganized into a predetermined crystal structure by vitrification, crystallization or the like. At this time, phosphorus (P) and sulfur (S) atoms agglomerate to form anionic clusters. A change in compositional ratio between lithium (Li), phosphorus (P) and sulfur (S) elements may affect the distribution of the anionic clusters of the sulfide-based solid electrolyte. The present invention includes further adding, as a raw material, simple-substance phosphorus, which combines with a sulfur (S) element, not a lithium (Li) compound or a sulfur (S) compound, to form an anionic cluster, apart from lithium sulfide (Li₂S), diphosphorus pentasulfide (P₂S₅) and lithium halide (LiX), to reduce the compositional ratio of the sulfur (S) element, and includes further adding selenium (Se) to incorporate the selenium (Se) element in an amount equivalent to the reduced ratio of sulfur (S) element into the argyrodite-type crystal structure of the sulfide-based solid electrolyte.

In addition, the method for preparing a sulfide-based solid electrolyte according to the present invention includes grinding the aforementioned mixture including raw materials by applying a strong force of 38G or more thereto. The selenium (Se) element can be more easily substituted in the crystal structure of the sulfide-based solid electrolyte by grinding the raw materials with a stronger force, as compared to conventional preparation methods. The grinding method is not particularly limited, but may be conducted using a ball mill such as an electric ball mill, a vibration ball mill or a planetary ball mill; a vibration mixer mill, a SPEX mill or the like. Preferably, a planetary ball mill is used. Specifically, when raw materials and beads are charged in a container and a planetary ball mill is then operated, the beads in the container rotate along the wall of the container. At this time, a fractional force is generated, which enables the raw materials to be ground. At this time, the rotation rate increases so as to apply an inertial force of 38G or more to the beads. As a result, the force of 38G or more can be applied to the raw materials as well.

The sulfide-based solid electrolyte prepared by the method has totally different properties from conventional materials. This will be analyzed by the following Examples and Test Examples.

### Example 1—Synthesis of Li₆PS_{4.75}Se_{0.25}Cl, a=0.25

A mixture containing lithium sulfide (Li₂S), diphosphorus pentasulfide (P₂S₅), lithium chloride (LiCl), selenium (Se) and simple-substance phosphorus in a molar ratio of 0.581:0.105:0.233:0.058:0.023 was prepared.

The mixture was charged in a gas-sealed milling container and beads made of zirconium oxide and having a diameter of 3 mm were charged therein. At this time, the amount of charged beads was about 20 times the weight of the raw materials. By the planetary ball mill method to generate an inertial force described above, the mixture was ground. Specifically, the container was rotated so as to apply a force of about 49G to the mixture, and one cycle including 30-minute grinding and 30-minute standing was repeated 18 times.

After completion of grinding, a powdery sulfide-based solid electrolyte was collected through appropriate sieving and mortar grinding.

### Example 2—Synthesis of Li₆PS_{4.50}Se_{0.50}Cl, a=0.50

A mixture containing lithium sulfide (Li₂S), diphosphorus pentasulfide (P₂S₅), lithium chloride (LiCl), selenium (Se) and simple-substance phosphorus in a molar ratio of 0.543:0.087:0.217:0.109:0.043 was prepared.

Grinding was conducted in the same manner as in Example 1 above to obtain a powdery sulfide-based solid electrolyte.

### Example 3—Synthesis of Li₆PS_{4.25}Se_{0.75}Cl, a=0.75

A mixture containing lithium sulfide (Li₂S), diphosphorus pentasulfide (P₂S₅), lithium chloride (LiCl), selenium (Se) and simple-substance phosphorus in a molar ratio of 0.510:0.071:0.204:0.153:0.061 was prepared.

Grinding was conducted in the same manner as in Example 1 above to obtain a powdery sulfide-based solid electrolyte.

### Comparative Example 1

A mixture containing lithium sulfide (Li₂S), diphosphorus pentasulfide (P₂S₅) and lithium chloride (LiCl) in a molar ratio of 0.625:0.125:0.25 was prepared.

A powdery sulfide-based solid electrolyte was obtained in the same manner as in Example 1, except that, in the step of grinding the mixture, the container was rotated to apply a force of about 37G to the mixture and the operation was continuously conducted for 12 hours.

### Comparative Example 2

A mixture containing lithium sulfide (Li₂S), diphosphorus pentasulfide (P₂S₅), lithium chloride (LiCl), selenium (Se) and simple-substance phosphorus in a molar ratio of 0.543:0.087:0.217:0.109:0.043 was prepared in the same manner as in Example 2.

Grinding was conducted in the same manner as in Comparative Example 1 above to obtain a powdery sulfide-based solid electrolyte.

### Comparative Example 3

A mixture containing lithium sulfide (Li₂S), diphosphorus pentasulfide (P₂S₅) and lithium chloride (LiCl) in a molar ratio of 0.625:0.125:0.25 was prepared.

Grinding was conducted in the same manner as in Example 1 above to obtain a powdery sulfide-based solid electrolyte.

### Test Example 1—Observation of Crystal Structure of Synthesized Sample by XRD Analysis

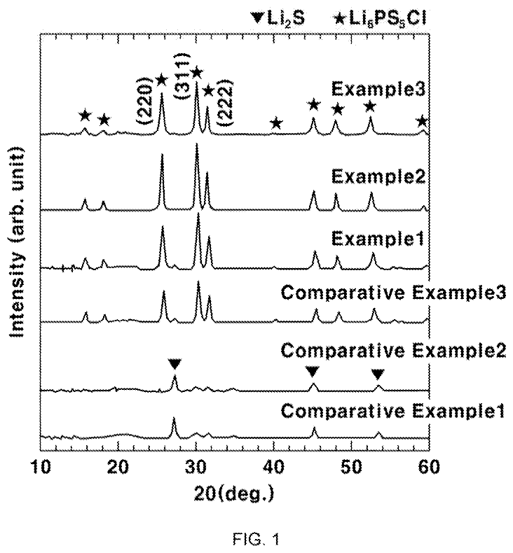

X-ray diffraction (XRD) analysis was conducted in order to analyze crystal structures of sulfide-based solid electrolytes according to Examples 1 to 3 and Comparative Examples 1 to 3. Each sample was loaded on a sealed holder for XRD applications and a range of 10°≤2θ≤60° was measured at a scanning rate of 2°/min. Results are shown in FIG. 1.

Results of Comparative Examples 1 and 2 showed that the peak corresponding to lithium sulfide (Li₂S) as a raw material was observed. In Comparative Examples 1 and 2, it can be seen that crystals were not formed because a weak force of about 37G was applied to the mixture of raw materials in the step of grinding.

On the other hand, results of Examples 1 to 3 and Comparative Example 3 showed that there was no peak of lithium sulfide (Li₂S) and a standard diffraction pattern of Li₆PS₅Cl, which corresponded to the peak of the argyrodite-type crystal structure, was observed. This means that the argyrodite-type crystal structure can be formed only by grinding when applying a force of 38G or more to the mixture of raw material in the step of grinding.

Specifically, the sulfide-based solid electrolytes according to Examples 1 to 3 showed peaks in the regions of 2θ=15.60°±1.00°, 2θ=18.04°±1.00°, 2θ=25.60°±1.00°, 2θ=30.12°±1.00°, 2θ=31.46°±1.00°, 2θ=40.05±1.00°, 2θ=45.26°±1.00°, 2θ=48.16°±1.00°, 2θ=52.66°±1.00° and 2θ=59.00±1.00°, when measuring X-ray diffraction (XRD) patterns using a CuKα-ray.

At this time, considering, among peaks of Examples 1 to 3 and Comparative Example 3, the peaks of (222) plane of argyrodite-type crystalline phases found in the region of 31.46°±1.00°, as a in the following Formula 1 increases, 29 of the peak of (222) plane shifts to a lower angle which corresponds to a decrease in an angle higher than 0° and not higher than 0.3°. This can be depicted as numbers by the following Table 1:

Li₆PS₅₋ₐSeₐX [Formula 1]

wherein X is at least one halogen element selected from the group consisting of fluorine (F), chlorine (Cl), bromine (Br) and iodine (I) elements; and a satisfies 0<a<3.

In addition, the full width at half maximum of the peak of (222) plane of Examples 1 to 3 is narrower than that of Comparative Example 3, which means that crystallinity of sulfide-based solid electrolytes according to Examples 1 to 3 is better than that of Comparative Example 3.

TABLE 1

| | | Shift value of | Full width at half |
|---|---|---|---|
| | | peak of | maximum of |
| Item | a in Formula 1 | (222) plane¹⁾ | peak of (222) plane²⁾ |
| Example 1 | 0.25 | −0.10° | 0.386° |
| Example 2 | 0.50 | −0.24° | 0.350° |
| Example 3 | 0.75 | −0.28° | 0.442° |
| Comparative | 0 | 0.00° | 0.423° |
| Example 3 | | | |

¹⁾A shift value having a negative number means a shift to a low angle.
²⁾Full width at half maximum (FWHM) of peak refers to a width of a peak at half (½) of the maximum height of the peak.

### Test Example 2—Observation of Crystalline Properties of Synthesized Sample by Raman Analysis

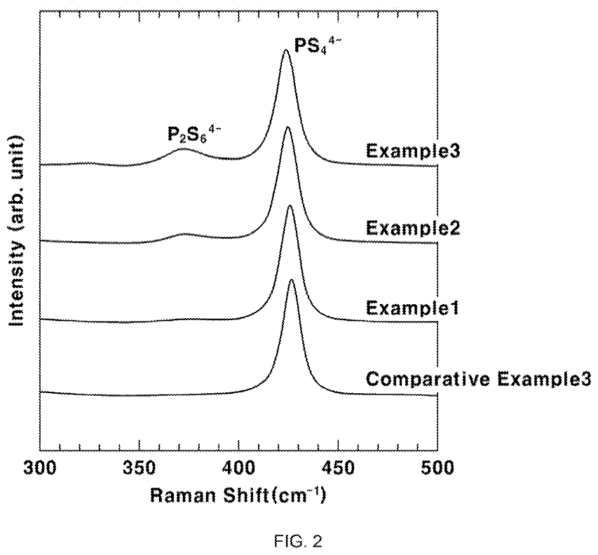

Raman spectroscopy was conducted in order to analyze crystalline properties of sulfide-based solid electrolytes according to Examples 1 to 3 and Comparative Example 3. Each sample was loaded on a sealed holder, the sample was irritated with an argon-ion laser with a wavelength of 514 nm for 60 seconds and the molecular vibration spectrum of the sample was measured. Results are shown in FIG. 2.

When compared with Comparative Example 3 wherein simple-substance phosphorus and selenium were not added as raw materials, not only the peak of PS₄⁻ at about 425 cm⁻¹, but also the peak of P₂S₆⁴⁻ at about 380 cm⁻¹ were observed from Raman spectrums of sulfide-based solid electrolytes according to Examples 1 to 3. That is, the sulfide-based solid electrolytes according to the present invention include PS₄³⁻ and P₂S₆⁴⁻ as anionic clusters.

A content ratio of PS₄³⁻ and P₂S₆⁴⁻ in the anionic clusters can be calculated from the areas of two peaks derived from PS₄³⁻ and P₂S₆⁴⁻ of the Raman spectrum of FIG. 2. The sulfide-based solid electrolyte according to the present invention may satisfy the following Equation 1:

$$80 \leq \frac{100 \times I ( {PS}_{4}^{3 -} )}{I ( {P}_{2} {S}_{6}^{4 -} ) + I ( {PS}_{4}^{3 -} )} < 100 \qquad [ Equation 1 ]$$

wherein I(P₂S₆⁴⁻) is an area of a Raman spectrum peak at about 380 cm⁻¹, and I(PS₄³) is an area of a Raman spectrum peak at about 425 cm⁻¹.

For reference, I(P₂S₆⁴⁻) does not necessarily mean an area of a peak accurately observed at a certain value of 380 cm⁻¹. I(P₂S₆⁴⁻) should be construed as meaning an area of the highest peak observed at about 380 cm⁻¹. In this way, I(PS₄³⁻) should be construed as well.

Raman spectrum results of sulfide-based solid electrolytes according to Examples 1 to 3 and Comparative Example 3 are applied to Equation 1 and results are shown in the following Table 2.

TABLE 2

| Item | $\frac{100 \times I ( {PS}_{4}^{3 -} )}{I ( {P}_{2} {S}_{6}^{4 -} ) + I ( {PS}_{4}^{3 -} )} [ \% ]$ |
|---|---|
| Example 1 | 93.22 |
| Example 2 | 89.23 |
| Example 3 | 82.36 |
| Comparative | 100.00 |
| Example 3 | |

As can be seen from the aforementioned results, sulfide-based solid electrolytes according to Examples 1 to 3 include PS₄³⁻ and P₂S₆⁴⁻ as anionic clusters, and PS43− is present in an amount of not lower than 80% and lower than 100%.

### Test Example 3—Measurement of Lithium Ion Conductivity by Alternating Current Impedance Analysis

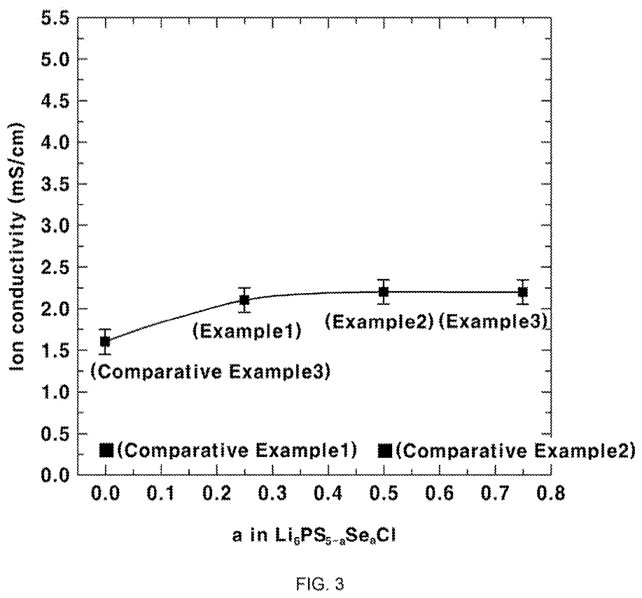

Alternating current impedance analysis was conducted at room temperature in order to measure lithium ion conductivity of sulfide-based solid electrolytes according to Examples 1 to 3 and Comparative Examples 1 to 3. Each powder was charged in a mold for measuring conductivity and a sample with a diameter of 6 mm and a thickness of 0.6 mm was produced by uniaxial cold pressing at 300 Mpa. An alternating voltage of 50 mV was applied to the sample and a frequency sweep was conducted from 1 Hz to 3 MHz to obtain impedance of the sample. Results are shown in FIG. 3 and Table 3.

TABLE 3

| Item | Lithium ion conductivity [mS/cm] |
|---|---|
| Example 1 | 2.1 |
| Example 2 | 2.2 |
| Example 3 | 2.2 |
| Comparative Example 1 | 0.25 |
| Comparative Example 2 | 0.25 |
| Comparative Example 3 | 1.6 |

As can be seen from XRD analysis results, Comparative Examples 1 and 2 have no crystallinity and thus have a low lithium ion conductivity of about 0.2 mS/cm.

As can be seen from results of Comparative Example 3 and Examples 1 to 3, the sulfide-based solid electrolytes including selenium (Se) according to the present invention (Examples 1 to 3) have higher lithium ion conductivity than a conventional material (Comparative Example 3) represented by Li₆PS₅Cl.

Hereinafter, a lithium ion-conducting sulfide-based solid electrolyte containing selenium and a method for preparing the same according another embodiment of the present invention will be described in detail. The same features as the one embodiment according to the present invention are omitted.

The method for preparing a sulfide-based solid electrolyte according to another embodiment of the present invention includes preparing a mixture containing lithium sulfide (Li₂S), diphosphorus pentasulfide (P₂S₅), lithium halide (LX), selenium (Se) and simple-substance phosphorus, grinding the mixture, and heat-treating the ground mixture.

Heat treatment conditions are not particularly limited, but heat treatment may be carried out at a temperature higher than a crystallization temperature of the ground mixture. For example, the ground mixture may be heat-treated at a temperature of 300° C. to 1,000° C. for 1 to 100 hours.

After heat treatment, the crystallinity of the mixture is improved and, as a result, lithium ion conductivity is greatly improved.

The sulfide-based solid electrolyte prepared by the method has totally different properties from conventional materials. This will be analyzed by the following Example and Test Example.

### Example 4—Synthesis of Li₆PS_{4.75}Se_{0.25}Cl, a=0.25

The powder obtained in Example 1 was heat-treated under an inert argon gas atmosphere at a temperature of about 550° C. for about 2 hours. After heat-treating, a powdery sulfide-based solid electrolyte was collected through appropriate sieving and mortar grinding.

### Example 5—Synthesis of Li₆PS_{4.50}Se_{0.50}Cl, a=0.50

The powder obtained in Example 2 was heat-treated under an inert argon gas atmosphere at a temperature of about 550° C. for about 2 hours. After heat-treating, a powdery sulfide-based solid electrolyte was collected through appropriate sieving and mortar grinding.

### Example 6—Synthesis of Li₆PS_{4.25}Se_{0.75}Cl, a=0.75

The powder obtained in Example 3 was heat-treated under an inert argon gas atmosphere at a temperature of about 550° C. for about 2 hours. After heat-treating, a powdery sulfide-based solid electrolyte was collected through appropriate sieving and mortar grinding.

### Comparative Example 4

The powder obtained in Comparative Example 1 was heat-treated under an inert argon gas atmosphere at a temperature of about 550° C. for about 2 hours. After heat-treating, a powdery sulfide-based solid electrolyte was collected through appropriate sieving and mortar grinding.

### Comparative Example 5

The powder obtained in Comparative Example 2 was heat-treated under an inert argon gas atmosphere at a temperature of about 550° C. for about 2 hours. After heat-treating, a powdery sulfide-based solid electrolyte was collected through appropriate sieving and mortar grinding.

### Comparative Example 6

The powder obtained in Comparative Example 3 was heat-treated under an inert argon gas atmosphere at a temperature of about 550° C. for about 2 hours. After heat-treating, a powdery sulfide-based solid electrolyte was collected through appropriate sieving and mortar grinding.

### Test Example 4—Observation of Crystal Structure of Synthesized Sample by XRD Analysis

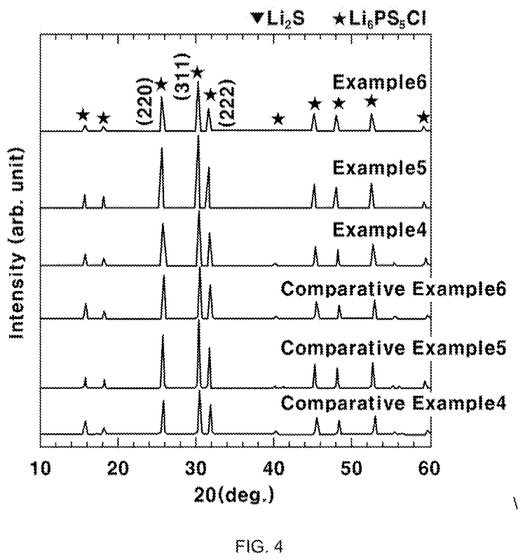

Crystal structures of sulfide-based solid electrolytes according to Examples 4 to 6 and Comparative Examples 4 to 6 were analyzed in the same manner as in Test Example 1. Results are shown in FIG. 4.

As can be seen from results of Examples 4 to 6, like results of Examples 1 to 3, a standard diffraction pattern of Li₆PS₅Cl, which was the peak of the argyrodite-type crystal structure, was observed. As compared with Examples 1 to 3 shown in FIG. 1, the full width at half maximum became much narrower. This means that the crystallinity of the sulfide-based solid electrolyte was further improved by the heat treatment.

In addition, in Examples 4 to 6 as well, 2θ of the peak of the (222) plane of the argyrodite-type crystalline phase observed in the region of 31.46°±1.00°, among peaks, shifts to a lower angle, which corresponds to a decrease in an angle higher than 0° and not higher than 0.3°. This can be depicted as numbers by the following Table 4.

TABLE 4

| | | | Full width at half |
|---|---|---|---|
| | | Shift value of | maximum of |
| Item | a in Formula 1 | peak of (222) plane | peak of (222) plane |
| Example 4 | 0.25 | −0.05 | 0.194 |
| Example 5 | 0.50 | −0.22 | 0.170 |
| Example 6 | 0.75 | −0.22 | 0.293 |
| Comparative | 0 | 0.00 | 0.199 |
| Example 6 | | | |

### Test Example 5—Observation of Crystalline Properties of Synthesized Sample by Raman Analysis

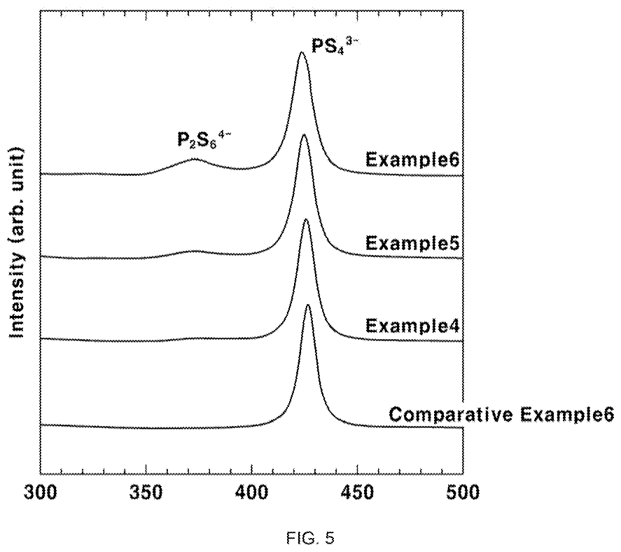

Crystal structures of sulfide-based solid electrolytes according to Examples 4 to 6 and Comparative Example 6 were analyzed in the same manner as in Test Example 2. Results are shown in FIG. 5.

As can be seen from results of Examples 4 to 6, like results of Examples 1 to 3, the peak of PS₄³⁻ was observed at about 425 cm⁻¹, and the peak of P₂S₆⁴⁻ was observed at about 380 cm⁻¹. That is, sulfide-based solid electrolytes according to Examples 4 to 6 includes, as anionic clusters, PS₄³⁻ and P₂S₆⁴⁻.

A content ratio of PS₄³⁻ and P₂S₆⁴⁻ in the anionic clusters can be calculated from the areas of two peaks derived from PS₄³⁻ and P₂S₆⁴⁻ of the Raman spectrum of FIG. 5. This means that the sulfide-based solid electrolyte according to the present invention satisfies the following Equation 1:

$$80 \leq \frac{100 \times I ( {PS}_{4}^{3 -} )}{I ( {P}_{2} {S}_{6}^{4 -} ) + I ( {PS}_{4}^{3 -} )} < 100 \qquad [ Equation 1 ]$$

wherein I(P₂S₆⁴⁻) is an area of a Raman spectrum peak at about 380 cm⁻¹, and I(PS₄³⁻) is an area of a Raman spectrum peak at about 425 cm⁻¹.

Raman spectrum results of sulfide-based solid electrolytes according to Examples 4 to 6 and Comparative Example 6 are applied to Equation 1 and results are shown in the following Table 5.

TABLE 5

| Item | $\frac{100 \times I ( {PS}_{4}^{3 -} )}{I ( {P}_{2} {S}_{6}^{4 -} ) + I ( {PS}_{4}^{3 -} )} [ \% ]$ |
|---|---|
| Example 4 | 94.72 |
| Example 5 | 90.18 |
| Example 6 | 83.82 |
| Comparative | 100.00 |
| Example 6 | |

As can be seen from the aforementioned results, sulfide-based solid electrolytes according to Examples 4 to 6 include PS₄³⁻ and P₂S₆⁴⁻ as anionic clusters, and PS₄³⁻ is present in an amount of not lower than 80% and lower than 100%.

### Test Example 6—Measurement of Lattice Constant Using XRD Pattern

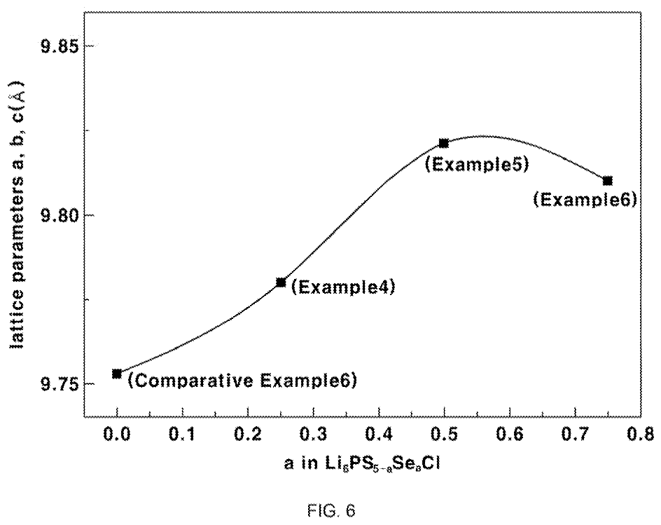

Lattice constants of samples according to Examples 4 to 6 and Comparative Example 6 were measured from peaks of XRD patterns obtained in Test Example 4. Results are shown in FIG. 6.

The lattice constants of Examples 4 to 6 and Comparative Example 6 were 9.77 Å, 9.82 Å, 9.81 Å and 9.75 Å, respectively. Although described later, the lattice constant (a=0.5) of Example 5 was the highest and thus lithium ion conductivity was the best.

### Test Example 7—Observation of Crystalline Properties of Synthesized Sample by ³¹P-NMR Analysis

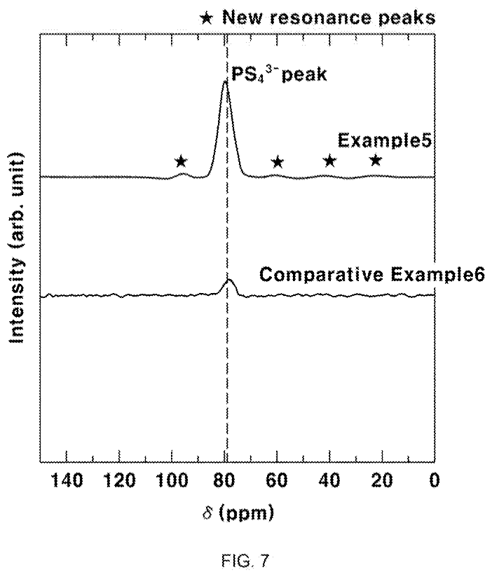

³¹P-NMR analysis was conducted in order to evaluate chemical changes of sulfide-based solid electrolytes according to Example 5 and Comparative Example 6. Each sample was charged in a container for NMR, and NMR was measured at a spinning rate of 5,500 Hz using a P31 probe. Obtained information was converted into data through Fourier transform. Results are shown in FIG. 7.

As can be seen from results of Example 5, in addition to the PS₄³⁻ main peak at 79 ppm, new resonance peaks were observed at 24.5 ppm, 41.5 ppm, 61.5 ppm and 97.0 ppm. On the other hand, results of Comparative Example 6 showed that only a peak was observed at 79 ppm and other peaks were not observed.

### Test Example 8—Measurement of Lithium Ion Conductivity by Alternating Current Impedance Analysis

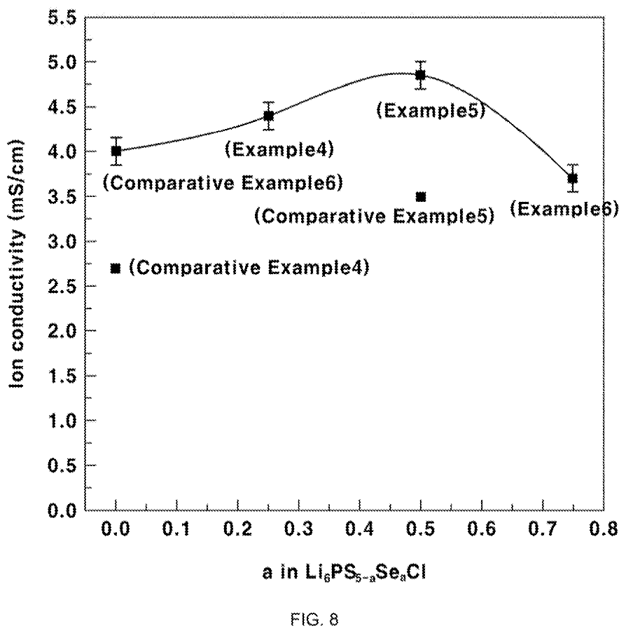

Lithium ion conductivity of sulfide-based solid electrolytes according to Examples 4 to 6 and Comparative Examples 4 to 6 was measured in the same manner as in Test Example 3. Results are shown in FIG. 8 and Table 6.

TABLE 6

| Item | Lithium ion conductivity [mS/cm] |
|---|---|
| Example 4 | 4.5 |
| Example 5 | 5.0 |
| Example 6 | 3.7 |
| Comparative Example 4 | 2.7 |
| Comparative Example 5 | 3.3 |
| Comparative Example 6 | 4.1 |

As can be seen from Table 6, when a in Formula 1 is 0.5 and heat treatment is conducted, the sulfide-based solid electrolyte of Example 5 exhibits considerably high lithium ion conductivity of 5.0 mS/cm.

The lithium ion-conducting sulfide-based solid electrolyte containing selenium according to the present invention can be used for all electrochemical cells using solid electrolytes. Specifically, the lithium ion-conducting sulfide-based solid electrolyte can be applied to a variety of fields and products including energy storage systems using secondary batteries, batteries for electric vehicles or hybrid electric vehicles, portable power supply systems for unmanned robots or Internet of things and the like.

As apparent from the foregoing, the lithium ion-conducting sulfide-based solid electrolyte containing selenium according to the present invention has high lithium ion conductivity of about 5 mS/cm.

The effects of the present invention are not limited to those mentioned above. It should be understood that the effects of the present invention include all effects that can be inferred from the description of the present invention.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A lithium ion-conducting sulfide-based solid electrolyte containing selenium represented by the following Formula 1 and having an argyrodite-type crystal structure:
Li₆PS₅₋ₐSeₐX [Formula 1]
wherein X is at least one halogen element selected from the group consisting of fluorine (F), chlorine (Cl), bromine (Br) and iodine (I) elements; and
a satisfies 0<a<3.

2. The lithium ion-conducting sulfide-based solid electrolyte containing selenium according to claim 1, wherein the lithium ion-conducting sulfide-based solid electrolyte has a peak in ranges of 2θ=15.60°±1.00°, 2θ=18.04°+1.00°, 2θ=25.60°±1.00°, 2θ=30.12°±1.00°, 2θ=31.46°±1.00°, 2θ=40.05±1.00°, 2θ=45.26°±1.00°, 2θ=48.16°±1.00°, 2θ=52.66°±1.00° and 2θ=59.00±1.00° when measuring X-ray diffraction (XRD) patterns using a CuKα-ray.

3. The lithium ion-conducting sulfide-based solid electrolyte containing selenium according to claim 1, wherein, as a in Formula 1 increases, in the X-ray diffraction (XRD) patterns using a CuKα-ray, a 2θ value of a peak of (222) plane of an argyrodite-type crystalline phase shifts to a lower angle which corresponds to a decrease in an angle higher than 0° and not higher than 0.3°.

4. The lithium ion-conducting sulfide-based solid electrolyte containing selenium according to claim 1, wherein the lithium ion-conducting sulfide-based solid electrolyte has a distribution of anionic clusters of PS₄³⁻ and P₂S₆⁴⁻.

5. The lithium ion-conducting sulfide-based solid electrolyte containing selenium according to claim 1, wherein the lithium ion-conducting sulfide-based solid electrolyte satisfies the following Equation 1:
$$80 \leq \frac{100 \times I ( {PS}_{4}^{3 -} )}{I ( {P}_{2} {S}_{6}^{4 -} ) + I ( {PS}_{4}^{3 -} )} < 100 \qquad [ Equation 1 ]$$
wherein I(P₂S₆⁴⁻) is an area of a Raman spectrum peak at about 380 cm⁻¹; and
I(PS₄³⁻) is an area of a Raman spectrum peak at about 425 cm⁻¹.

6. The lithium ion-conducting sulfide-based solid electrolyte containing selenium according to claim 1, wherein a lattice constant of the argyrodite-type crystal structure is 9.75 Å to 9.85 Å.

7. The lithium ion-conducting sulfide-based solid electrolyte containing selenium according to claim 1, wherein the lithium ion-conducting sulfide-based solid electrolyte has a ³¹P-NMR spectrum having a peak in each of ranges of 20.0 ppm to 25.0 ppm, 40.0 ppm to 45.0 ppm, 60.0 ppm to 65.0 ppm and 95.0 ppm to 100.0 ppm.

8. A method for preparing a lithium ion-conducting sulfide-based solid electrolyte containing selenium comprising:
preparing a mixture comprising lithium sulfide (Li₂S), diphosphorus pentasulfide (P₂S₅) and lithium halide (LiX); and
grinding the mixture,
wherein the grinding of the mixture is carried out by adding selenium (Se) and simple-substance phosphorus to the mixture to substitute a part of sulfur elements by a selenium element, as shown in the following Formula 1:
Li₆PS₅₋ₐSeₐX [Formula 1]
wherein X is at least one halogen element selected from the group consisting of fluorine (F), chlorine (Cl), bromine (Br) and iodine (I) elements; and
a satisfies 0<a<3.

9. The method according to claim 8, wherein the sulfide-based solid electrolyte has an argyrodite-type crystal structure.

10. The method according to claim 8, wherein the grinding is carried out by applying a force of 38G or more to the mixture.

11. The method according to claim 8, further comprising:
heat-treating the ground mixture at a temperature of 300° C. to 1,000° C. for 1 to 100 hours.

12. The method according to claim 8, wherein, as a in Formula 1 increases, in the X-ray diffraction (XRD) patterns using a CuKα-ray, a 2θ value of a peak of (222) plane of an argyrodite-type crystalline phase shifts to a lower angle which corresponds to a decrease in an angle higher than 0° and not higher than 0.3°, and
the lithium ion-conducting sulfide-based solid electrolyte has a distribution of anionic clusters of PS₄³⁻ and P₂S₆⁴⁻ and satisfies the following Equation 1:
$$80 \leq \frac{100 \times I ( {PS}_{4}^{3 -} )}{I ( {P}_{2} {S}_{6}^{4 -} ) + I ( {PS}_{4}^{3 -} )} < 100 \qquad [ Equation 1 ]$$
wherein I(P₂S₆⁴⁻) is an area of a Raman spectrum peak at about 380 cm⁻¹; and
I(PS₄³⁻) is an area of a Raman spectrum peak at about 425 cm⁻¹.

13. The method according to claim 11, wherein the lithium ion-conducting sulfide-based solid electrolyte has an argyrodite-type crystal structure,
the argyrodite-type crystal structure has a lattice constant of 9.75 Å to 9.85 Å, and
the lithium ion-conducting sulfide-based solid electrolyte has a ³¹P-NMR spectrum having a peak in each of ranges of 20.0 ppm to 25.0 ppm, 40.0 ppm to 45.0 ppm, 60.0 ppm to 65.0 ppm and 95.0 ppm to 100.0 ppm.
